(19) United States
(12) Patent Application Publication
(10) Pub. No.: US 2017/0120732 A1
(43) Pub. Date: May 4, 2017

(54) Sun Snug

(71) Applicant: Solmi Roh, Cypress, CA (US)

(72) Inventor: Solmi Roh, Cypress, CA (US)

(21) Appl. No.: 15/338,365

(22) Filed: Oct. 29, 2016

Related U.S. Application Data
(60) Provisional application No. 62/248,669, filed on Oct. 30, 2015.

(51) Int. Cl. B60J 3/02

(52) U.S. Cl. CPC B60J 3/0286

(57) ABSTRACT

A sun snug comprises a sunscreen that is adapted to cover an automotive window, a horizontal moving device that moves the sun screen horizontally within the horizontal span of the automotive window, a vertical moving device moves the sun screen vertically within the vertical span of the automotive window and a closing device that partially closes the screen at an arbitrary point along a vertical line. The sunscreen comprises a plurality of pockets positioned along its lower end. The horizontal moving device comprises a plurality of clips attached on a top end of the sun screen, which slide on an upper edge of the automotive window. The vertical moving device comprises two strings and two S-shaped clips that secure the strings. The sunscreen further comprises four suction cups, or magnetic holding devices that are attracted by a steel frame surrounding the automotive window.

### CROSS-REFERENCE TO RELATED APPLICATION

This application claims priority on Provisional Application No. 62/248,669 filed on Oct. 30, 2015, the disclosure of which incorporated herein as if it is fully set forth.

### FIELD OF THE INVENTION

The present invention pertains to the field of automobile accessories, and more specifically to the field of window sunshades.

### BACKGROUND OF THE INVENTION

The prior art has put forth several designs for window sunshades, Among these are: U.S. Pat. No. 6,691,762 to Sunny Huang describes a collapsible automobile shade comprising a pleated screen which is selectively moved between an opened position and a collapsed position. The shade is mountable to an automobile's visor to shade a vehicle from sunlight which enters the car through the front windshield or to a side window of a vehicle to shade the vehicle from sunlight which enters the vehicle through a side window of the vehicle. The shade includes a mounting assembly to mount the shade to the visor or the side window. A strap closure extends around the shade to maintain the shade in a collapsed position as needed. U.S. Pat. No. 5,588,476 to Brig E. A. Trethewey describes a removable window shade that is secured adjacently to a roll down vehicular window along the top edge by a pair of suction cups. At least one suction cup detachably secures a lower folded edge of the window shade to the window. The lower suction cup includes a pressure relief mechanism to permit facile detachment and reattachment between the suction cup and the window to permit displacement of the lower part of the window shade from the window prior to rolling down the window. U.S. Pat. No. 3,025,098 to Aaron A. Andrews describes a sunshade for automobile windows comprising an elongated channel adapted to engage the upper edge of a window. A sheet of pliable material is secured along one of its edges to said channel adjacent the free edge of one of the side walls thereof and at no other point. The said sheet slidably extends around the interior walls of said channel to the free edge of the opposite side wall thereof and depends therefrom. None of these prior art references describe the present invention.

### SUMMARY OF THE INVENTION

It is an object of the present invention to provide an easily installable and easily removable sunshade particularly configured for rear windows of passenger motor vehicles.

To achieve the object, the present invention provides a sun snug comprising a sunscreen that is adapted to cover an automotive window, wherein the sunscreen blocks ultraviolet ray; a horizontal moving device that is adapted to move the sunscreen horizontally within the horizontal span of the automotive window; and a vertical moving device that is adapted to move the sunscreen vertically within the vertical span of the automotive window.

The horizontal moving device comprises a plurality of clips attached on a top end of the sunscreen. The clips are adapted to slide on an upper edge of the automotive window.

The horizontal moving device further comprises a first holding device that holds the sunscreen when the sunscreen is rolled up vertically. Preferably, the first holding device comprises one or more top holding straps that are provided on the top end of the sunscreen.

The sunscreen comprises a second holding device that holds the sunscreen when the sunscreen is rolled up horizontally. Preferably, the second holding device comprises a side holding strap that is provided on a side end of the sunscreen.

The vertical moving device comprises two strings and two S-shaped clips that secure the strings. The S-shaped clips are provided on the top end of the sunscreen. Preferably, the clips of the horizontal moving device comprises the S-shaped clips of the vertical moving device.

A top half of the S-shaped clip is adapted to slide on the top edge of the automotive window, and a bottom half of the S-shape clip secures the string.

The sunscreen further comprises four suction cups. Two of the suction cups are located on the top corners of the sun screen and two of the suction cups are located on the half way down of the sun screen's side ends.

The horizontal moving device further comprises a plurality of magnetic holding devices that are adapted to be attracted by a steel frame surrounding the automotive window.

The sun snug further comprises a closing device that partially closes the sunscreen at an arbitrary point along a vertical line. The closing device comprises a third holding device that holds the sunscreen at the arbitrary point.

The sunscreen further comprises a plurality of pockets positioned along its lower end. Preferably, the pockets are made of mesh. The sunscreen is made of a breathable and machine washable fabric. The sunscreen comprises designs printed thereon. The sunscreen is rectangular and preferably has a height from about fifteen (15) inches to twenty-five (25) inches, and a width from about twenty (20) to forty (40) inch. More preferably, the height of the sunscreen is about twenty (20) inch and the width of the sunscreen is about thirty (30) inch.

Sun Snugs provide motorists with an easy to use and highly effective means of protecting their rear seat passengers from harmful effects of UV radiation in sunlight. Sun Snugs provide shade for youngsters and presents them with colorful prints and characters sure to catch their eyes and occupy their imaginations. With roomy storage pockets for items ranging from baby wipes, to crayons and coloring books, Sun Snugs help organise children's essential gear. Durably constructed from high quality materials, Sun Snugs will last for many years.

### BRIEF DESCRIPTION OF THE DRAWINGS

The accompanying drawings illustrate the best embodiments of the present invention. In the drawings:

FIG. 1 is a prototypical, functionally installed view of the present invention functioning as a curtain, extended across its top portion and securably retracted at its middle portion, to provide shade from sun shining into the top portion of the rear passenger window of a motor vehicle;

FIG. 2 is a prototypical uninstalled view of the present invention showing a sun shade fully extended for total shade;

FIG. 3 is a prototypical, functionally installed view of the present invention showing a sun shade functioning as a curtain in a retracted state that is useful on cloudy overcast days so rear passengers have light and a view from the rear passenger window of a motor vehicle;

FIG. 4 is a prototypical uninstalled diagonal view of the present invention showing how it functions as a shade instead of a curtain and is securably raised for open views, transport and storage;

FIG. 5 is a schematic elevation view showing the sun snug installed on a rear automotive window;

FIG. 6 is an elevation view of the sun snug;

FIG. 7 is a partial cross-sectional view showing a clip of a horizontal moving device for the sun snug;

FIG. 8 is a partial cross-sectional view showing an S-shaped clip of a vertical moving device for the sun snug;

FIG. 9 is a schematic view showing magnetic holding devices;

FIG. 10 is a schematic view showing a closing device for the sun snug;

FIG. 11 is a partial cross-sectional view showing details of the clip of the horizontal moving device; and

FIGS. 12-21 are photographs showing the essential functions of the sun snug.

### DETAILED DESCRIPTION OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success. Parents and caregivers who drive with a child in their back seat have an essential need to protect that child. Children are secured in child car seats or buckled into seat belts and harnesses when they are a little older. In addition to being protected in case of an accident, children also need to be protected from damaging effects of sunlight.

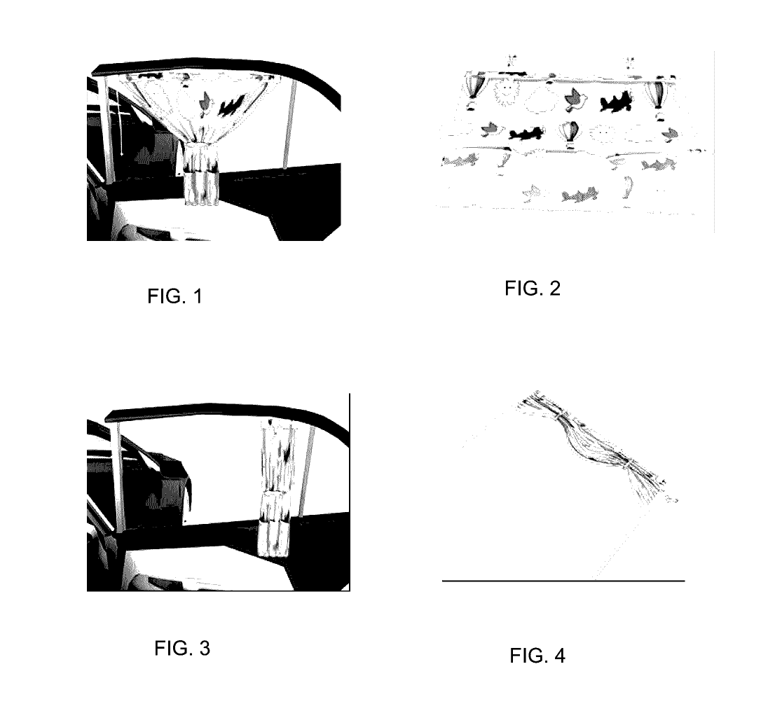

Referring to FIGS. 1-4, The present invention, hereinafter referred to as the Sun Snug Shade or Sun Snag 10, is an easily installable and easily removable sunshade particularly configured for rear windows of passenger motor vehicles. The Sun Snug is constructed in breathable, machine washable, quick drying polyester and nylon fabric. This fabric is opaque, preventing the passage of light and blocking approximately one hundred percent of incoming ultraviolet or UV rays. Air flows through the Sun Snug, keeping the temperature inside low. The Sun Snug fabric has festive bright prints and patterns including colorful, animated characters, flowers, animals, letters and numbers. Styles and colors vary widely, so motorists can select appropriate prints for their rear seat passengers who range from toddlers to teens to senior citizens.

Measuring approximately twenty inches in height and thirty inches in width, the Sun Snug is configured for easy installation and removal with virtually any passenger vehicle rear window. The Sun Snug is packaged in sets of two shades to cover a right rear passenger window and a left rear passenger window. Referring to FIG. 2, integrated into the bottom of the sunshade of the Sun Snug are approximately three pockets 62 that measure approximately ten inches in width by six and seven tenths inches in height. These pockets are made of a mesh fabric so users can easily view and recognize the contents of the pocket. Various sizes of the Sun Snug are available for different size windows.

The Sun Snug is different from other vehicular sunshades in that it uses clips 20 for fastening security rather than just suction cups.

Four clips run along the top of the sunshade 12 and function together to hook the sunshade to the window. These clips gently clip over the top edge of a slightly lowered window. The Sun Snug is pushable to one side much like a curtain, since the clips on the top can slide along the top of the window. The Sun Snug also can be roiled up vertically or horizontally. When rolled up vertically, two straps 28 on the top hold it in place. When rolled, up horizontally, a strap 32 on the side will hold the Sun Snug in place. These straps securely hold the Sun Snug in place by means of button or hook and loop fasteners.

Referring to FIG. 4, the Sun Snug also works as a blind. Strings 36 on each side help roil the Sun Snug up and down. These strings are secured to approximately two S shaped clips 38 located in the middle of the top port ion of the Sun Snug. The top half 40 of these S shaped clips remain attached to the window while the bottom half 42 is used to secure the side strings. Arranged in such a manner, children are unable to get to the cords, preventing a child from sucking on the cords or becoming entangled in the cords. For added security, the Sun Snug contains approximately four suction cups 44, two located on the top corners and two located halfway down the Sun Snug on both sides. These suction cups stick to the window and allow the sunshade to be fixed in a half raised position.

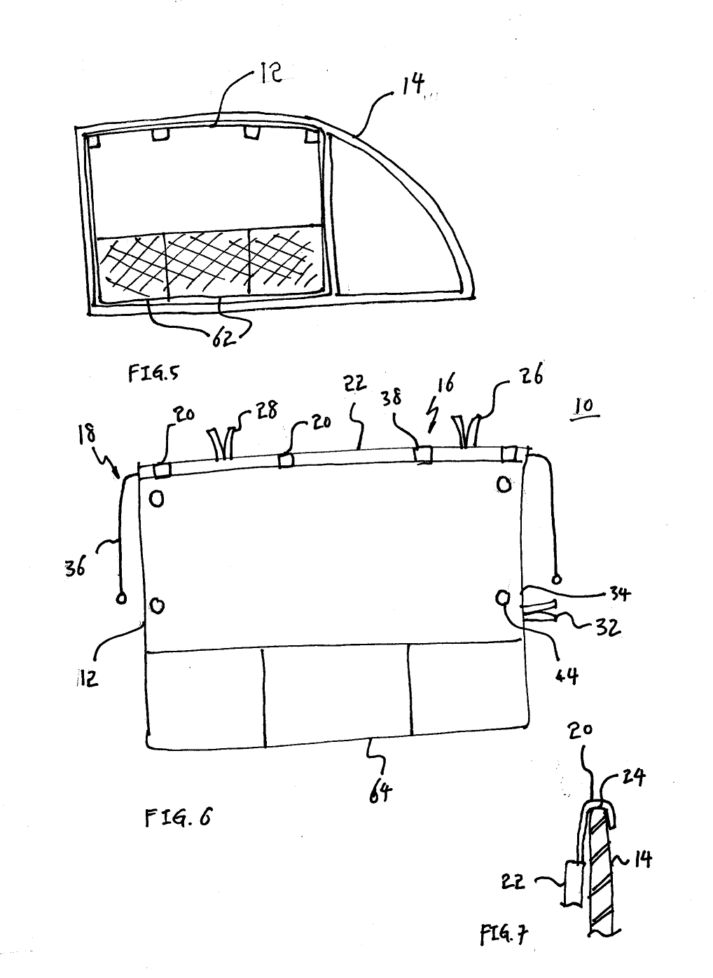

The present invention is explained again based on the claim structure. FIGS. 5 and 6 show a sun snug 10 comprising a sunscreen 12 that is adapted to cover an automotive window 14, wherein the sunscreen 12 blocks ultraviolet ray; a horizontal moving device 16 that is adapted to move the sunscreen 12 horizontally within the horizontal span of the automotive window 14; and a vertical moving device 18 that is adapted to move the sunscreen 12 vertically within the vertical span of the automotive window 14.

The horizontal moving device 16 comprises a plurality of clips 20 attached on a top end 22 of the sunscreen 12. Referring to FIG. 7, the clips 20 are adapted to slide on an upper edge 24 of the automotive window 14. FIG. 11 shows details of the clip 20. The clip 20 comprises a hook 70 that slides on the upper edge of the automotive window 14, a base 74 that is sewn with a string 76 through holes of the base to the sunscreen 12, and a spacer 72 that is adapted to keep a predetermined distance between the sunscreen 12 and the automotive window 14.

The horizontal moving device 16 further comprises a first holding device 26 that holds the sunscreen 12 when the sunscreen 12 is roiled up vertically as shown on FIG. 4. Preferably, the first holding device 26 comprises one or more top holding straps 28 that are provided on the top end 22 of the sunscreen 12.

The sunscreen 12 comprises a second holding device 30 that holds the sunscreen 12 when the sunscreen 12 is roiled up horizontally as shown of FIG. 3. Preferably, the second holding device 30 comprises a side holding strap 32 that is provided on a side end 34 of the sun screen 12.

The vertical moving device 18 comprises two strings 36 and two S-shaped clips 38 that secure the strings 36. The S-shaped clips 38 are provided on the top end 22 of the sunscreen 12. Preferably, the clips 20 of the horizontal moving device 16 comprises the S-shaped clips 38 of the vertical moving device 18.

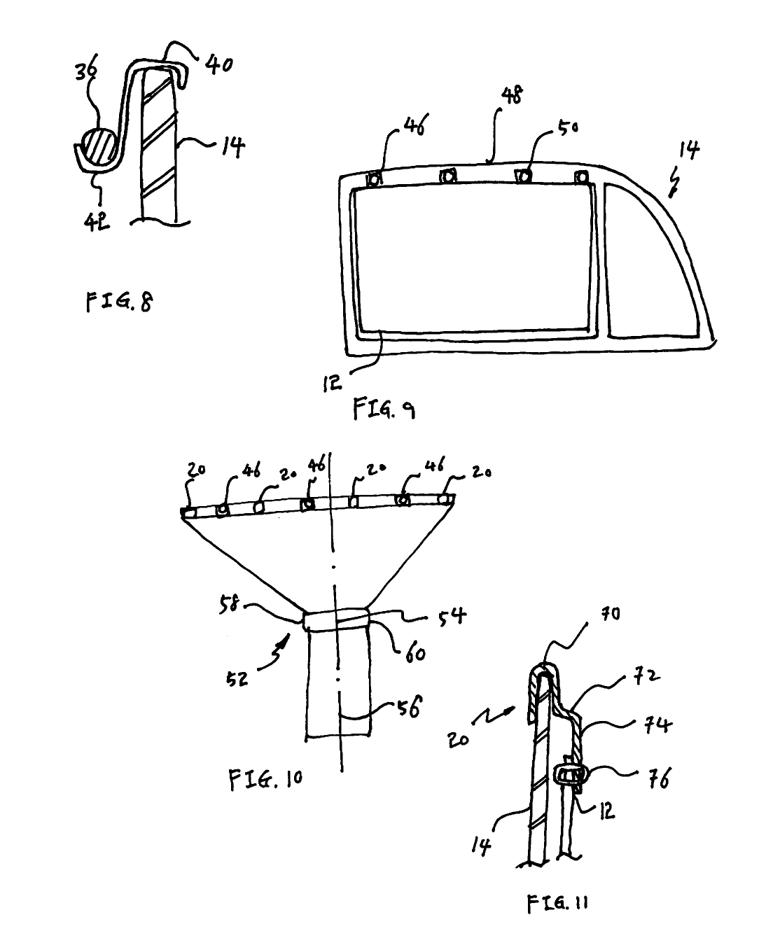

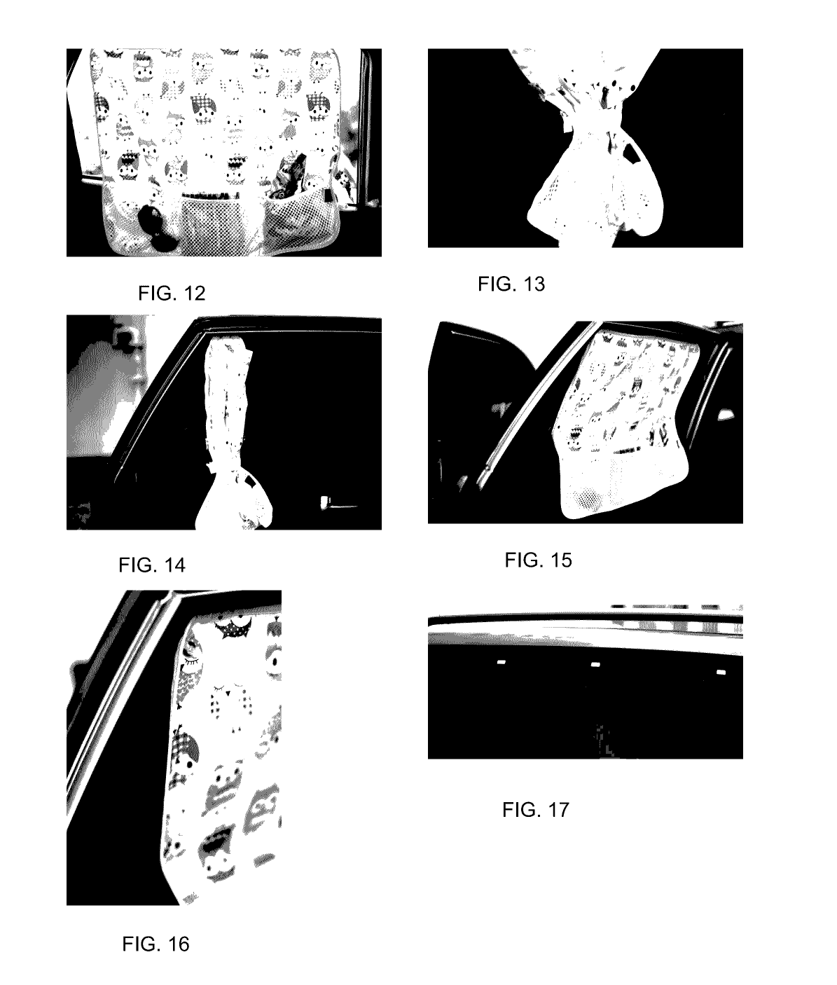

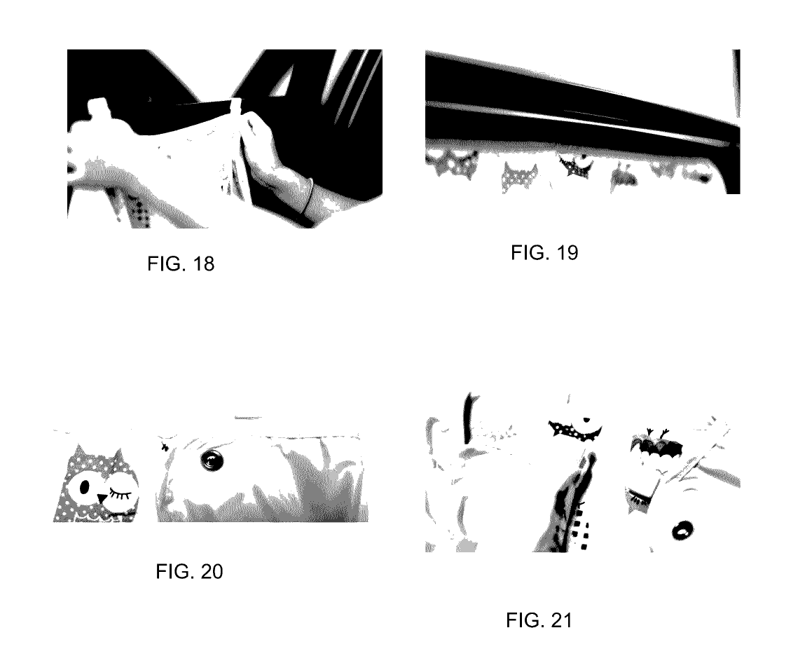

Referring to FIG. 8, a top half 40 of the S-shaped clip 38 is adapted to slide on the top edge 24 of the automotive window 14, and a bottom, half 42 of the S-shape clip 38 secures the string 36. When the string 36 is pulled, the sunscreen 12 is closed as shown on FIG. 4, The strings 36 are attached on a plurality of points on the sunscreen 12.

Referring back to FIG. 6, the sunscreen 12 further comprises four suction cups 44. Two of the suction cups 44 are located on the top corners of the sunscreen 12 and two of the suction caps 44 are located on the half way down of the sun screen's side ends 34.

Referring to FIG. 9, the horizontal moving device 16 further comprises a plurality of magnetic holding devices 46 that are adapted to be attracted by a steel frame 48 surrounding the automotive window 14. The magnetic holding device 46 may be a button-shaped magnet 50 that is sewn to the sunscreen 12. Preferably, as shown on FIG. 10, The magnetic holding devices 46 are positioned between the clips 20 of the horizontal moving device 16. The magnets 50 facilitate positioning of the clips 20 when a user installs the sun snug 10 on the automotive window. Alternatively, only magnets 50 can be used to attach the sun snug 10 on the steel frame 48 for simple installation when there are no children.

Referring to FIG. 10, The sun snug 10 further comprises a closing device 52 that partially closes the sunscreen 12 at an arbitrary point 54 along a vertical line 56 as shown on FIG. 1. The closing device 52 comprises a third holding device 58 that holds the sunscreen 12 at the arbitrary point 54. The third holding device 58 may be a fabric band 60.

Referring back to FIG. 5, the sunscreen 12 further comprises a plurality of pockets 62 positioned along its lower end 64. Preferably, the pockets 62 are made of mesh. The sunscreen 12 is made of a breathable and machine washable fabric. The sunscreen 12 comprises designs printed thereon. The sunscreen 12 is rectangular and preferably has a height from about fifteen (15) inches to twenty-five (25) inches, and a width from about twenty (20) to forty (40) inch. More preferably, the height of the sunscreen is about twenty (20) inch and the width of the sunscreen is about thirty (30) inch.

Although this invention has been described with respect to specific embodiments, it is not intended to be limited, thereto and various modifications which will become apparent to the person of ordinary skill in the art are intended to fall within the spirit and scope of the invention as described herein taken in conjunction with the accompanying drawings and the appended claim.

1. A sun snug comprising:
a) a sunscreen that is adapted to cover an automotive window, wherein the sunscreen blocks ultraviolet ray;
b) a horizontal moving device that is adapted to move the sunscreen horizontally within the horizontal span of the automotive window;
c) a vertical moving device that is adapted to move the sunscreen vertically within the vertical span of the automotive window.

2. The sun snug of claim 1, wherein the horizontal moving device comprises a plurality of clips attached on a top end of the sunscreen, wherein the clips are adapted to slide on an upper edge of the automotive window.

3. The sun snug of claim 2, wherein the clip comprises a hook that is adapted to slide on the upper edge of the automotive window, a base that is fixed the sunscreen, and a spacer that is adapted to keep a predetermined distance between the sunscreen and the automotive window.

4. The sun snug of claim 3, wherein the horizontal moving device further comprises a first holding device that holds the sunscreen when the sunscreen is rolled up vertically, wherein the first holding device comprises one or more top holding straps that are provided on the top end of the sunscreen.

5. The sun snug of claim 3, wherein the sunscreen comprises a second holding device that holds the sunscreen when the sunscreen is rolled up horizontally.

6. The sun snug of claim wherein the second holding device comprises a side holding strap that is provided on a side end of the sunscreen.

7. The sun snug of claim 2, wherein the vertical moving device comprises two strings and two S-shaped clips that secure the strings.

8. The sun snug of claim 1, wherein the S-shaped clips are provided on the top end of the sunscreen.

9. The sun snug of claim 8, wherein the clips of the horizontal moving device comprises the S-shaped clips of the vertical moving device.

10. The sun snug of claim wherein a top half of the S-shaped clip is adapted to slide on the top edge of the automotive window, and a bottom half of the S-shape clip secures the string.

11. The sun snug of claim 10, wherein the sunscreen further comprises four suction cups, wherein two of the suction cups are located on the top corners of the sunscreen and two of the suction cups are located on the half way down of the sunscreen's side ends.

12. The sun snug of claim 10, wherein the horizontal moving device further comprises a plurality of magnetic holding devices that are adapted to be attracted by a steel frame surrounding the automotive window, wherein the magnetic holding devices are positioned between the clips of the horizontal moving device.

13. The sun snug of claim 10, further comprising a closing device that partially closes the sunscreen at an arbitrary point along a vertical line.

14. The sun snug of claim 13, wherein the closing device comprises a third, holding device that holds the sunscreen at the arbitrary point.

15. The sun snug of claim 14, wherein the sunscreen, further comprises a plurality of pockets positioned along its lower end.

16. The sun snug of claim 15, wherein the pockets are made of mesh.

17. The sun snug of claim 16, wherein the sunscreen, is made of a breathable and machine washable fabric.

18. The sun snug of claim 17, wherein the sunscreen comprises designs printed thereon.

19. The sun snug of claim 18, wherein the sunscreen is rectangular and has a height from about fifteen (15) inches to twenty-five (25) inches, and a width from about twenty (20) to sunscreen is about thirty (30) inch.
